(19) United States
(12) Patent Application Publication
(10) Pub. No.: US 2013/0150118 A1
(43) Pub. Date: Jun. 13, 2013

(54) USER TERMINAL AND COMMUNICATION METHOD

(71) Applicant: FUJITSU MOBILE COMMUNICATIONS LIMITED, Kawasaki-shi (JP)

(72) Inventor: Akitsugu HOMMA, Kawasaki (JP)

(73) Assignee: FUJITSU MOBILE COMMUNICATIONS LIMITED, Kawasaki-shi (JP)

(21) Appl. No.: 13/664,247

(22) Filed: Oct. 30, 2012

(30) Foreign Application Priority Data
Dec. 9, 2011 (JP) 2011-270587

(51) Int. Cl. H04W 88/06

(52) U.S. Cl. 455/552.1

(57) ABSTRACT

A user terminal includes a first wireless interface configured to perform a wireless communication according to a first communication system, a second wireless interface configured to perform a wireless communication according to a second communication system of which an accessible area is narrower than an accessible area of the first communication system, and a control unit configured to perform control to acquire non-real-time reproducing data from the second wireless interface while the user terminal is being moved.

### CROSS-REFERENCE TO RELATED APPLICATION

This patent application is based upon, and claims the benefit of priority of Japanese Patent Application No. 2011-270587 filed on Dec. 9, 2011, the entire contents of which are incorporated herein by reference.

### FIELD

The embodiments discussed herein are related to a wireless communication system.

### BACKGROUND

The communication system includes a first type of the communication system wirelessly accessible to a wide area, and a second type of the communication system wirelessly accessible to a narrow area.

The first type of the communication system wirelessly accessible to a wide area includes a wireless access system such as code division multiple access (CDMA) and the like. A wireless communication device configured to perform a wireless communication according to the communication system wirelessly accessible to a wide area communicates data while a user terminal is moved by handing over the data between base stations.

On the other hand, the second type of the communication system wirelessly accessible to a narrow area includes a wireless access system such as a wireless local area network (wireless LAN), and the like. A wireless communication device configured to perform a wireless communication according to the communication system wirelessly accessible to a narrow area communicate data only within an area covered by the base station, and does not communicate data (i.e., the communication is cut off) when the user terminal is moved out of the area covered by that base station.

Japanese Laid-open Patent Publication No. 2004-72136 (hereinafter referred to as “Patent Document 1”) discloses a mobile communication terminal device configured to select a communication system wirelessly accessible to a narrow area when the user terminal is unmoved, and select a communication system wirelessly accessible to a wide area when the user terminal is moved.

### RELATED ART DOCUMENT

### Patent Document

Patent Document 1: Japanese Laid-open Patent Publication No. 2004-72136

The communication system wirelessly accessible to a wide area may perform communications by accessing an area covered by one base station that is frequently wider than an area covered by another base station utilizing the communication system wirelessly accessible to a narrow area. In this case, since communications are performed between one base station covering the wide area and numerous user terminals, higher communication load may be imposed upon the base station covering the wide area.

The communication system wirelessly accessible to a narrow area may perform communications by accessing a narrow area covered by the base station, so that communications may be performed between one base station covering the narrow area and only a limited number of user terminals. Accordingly, communication load imposed upon the base station covering the narrow area may scarcely become high.

Data transmitted from the base station to the user terminal includes data that are reproduced in real time, and data that are not reproduced in real time in the user terminal. The data that are reproduced in real time include consecutive data such as streaming data. The data that are not reproduced in real time include inconsecutive data such as program information.

For example, the wireless communication system wirelessly accessible to a narrow area is configured to be selected when the user terminal is unmoved, and the wireless communication system wirelessly accessible to a wide area is configured to be selected when the user terminal is moved. In this case, the wireless communication system wirelessly accessible to a wide area may be utilized regardless of data to be reproduced while the user terminal is being moved. As a result, the communication load on the base station utilizing the wireless communication system wirelessly accessible to a wide area may become increasingly high.

### SUMMARY

According to an aspect of the embodiments, there is provided a user terminal that includes a first wireless interface configured to perform a wireless communication according to a first communication system; a second wireless interface configured to perform a wireless communication according to a second communication system of which an accessible area is narrower than an accessible area of the first communication system; and a control unit configured to perform control to acquire non-real-time reproducing data from the second wireless interface while the user terminal is being moved.

The object and advantages of the invention will be realized and attained by means of the elements and combinations particularly pointed out in the appended claims.

It is to be understood that both the foregoing general description and the following detailed description are exemplary and explanatory and are not restrictive of the invention.

Additional objects and advantages of the embodiments will be set forth in part in the description which follows, and in part will be obvious from the description, or may be learned by practice of the invention.

### BRIEF DESCRIPTION OF THE DRAWINGS

FIG. 1 is a diagram illustrating a wireless communication system according to an embodiment;

FIG. 2 is a diagram illustrating data to be distributed according to an embodiment;

FIG. 3 is a diagram illustrating a user terminal according to an embodiment;

FIG. 4 is a functional block diagram illustrating the user terminal according to the embodiment;

FIG. 5 is a diagram illustrating data to be displayed on the user terminal according to the embodiment;

FIG. 6 is a flowchart illustrating an operation of the user terminal according to the embodiment;

FIG. 7 is a flowchart illustrating an operation of the user terminal according to the embodiment;

FIG. 8 is a flowchart illustrating an operation of the user terminal according to the embodiment;

FIG. 9 is a flowchart illustrating an operation of the user terminal according to the embodiment; and

FIG. 10 is a sequence diagram illustrating an operation of a wireless communication system according to an embodiment.

### DESCRIPTION OF EMBODIMENTS

Preferred embodiments are described below with reference to the accompanying drawings.

Note that same reference numerals represent same functions of all the drawings for illustrating the embodiments, and repeated descriptions of the same functions are omitted.

Wireless Communication System

A wireless communication system disclosed herein may select different communication systems based on a status of a user terminal and a type of data desired to be reproduced.

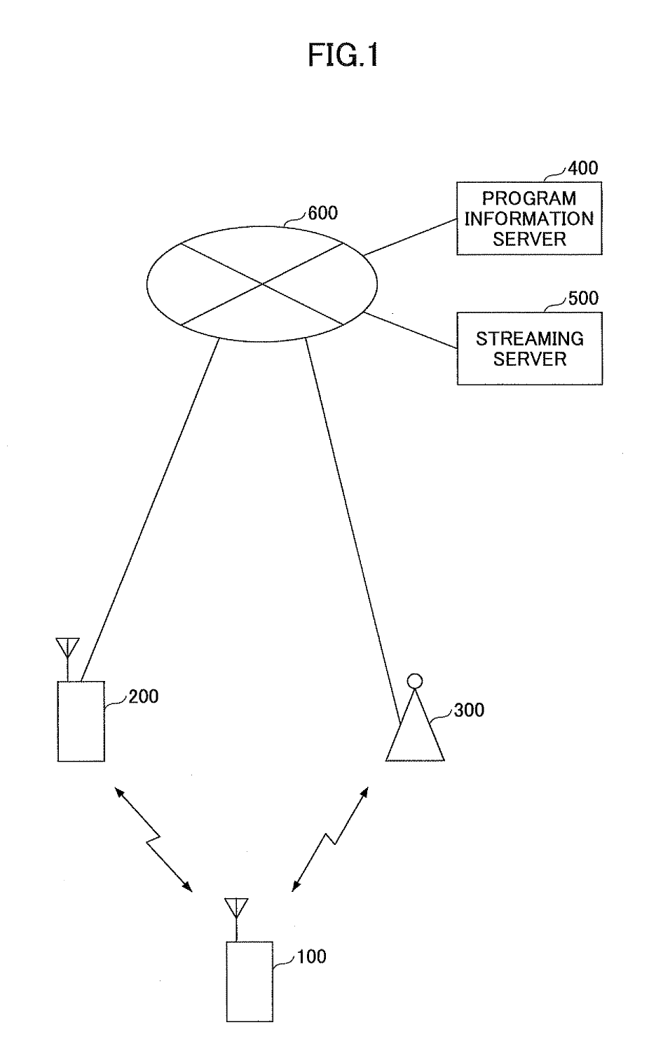

FIG. 1 is a diagram illustrating a wireless communication system according to an embodiment.

The wireless communication system includes a user terminal 100. The user terminal 100 includes a wireless interface configured to perform communication according to a first wireless communication system wirelessly accessible to a wide area. The user terminal 100 further includes a wireless interface configured to perform communication according to a second wireless communication system wirelessly accessible to a narrow area.

The user terminal 100 may be any mobile communication terminal insofar as the user is capable of performing communication with the user terminal 100. Examples of the user terminal 100 include a mobile phone, an information terminal, a personal digital assistant, a mobile personal computer, and the like; however, the user terminal 100 is not limited to these examples.

The user terminal 100 is configured to receive content. Examples of the content include data that are reproduced in real time (hereinafter referred to as “real-time reproducing data”), and data that are not reproduced in real time (hereinafter referred to as “non-real-time reproducing data”). The real-time reproducing data include consecutively reproducing data such as streaming data. The non-real-time reproducing data include inconsecutively reproducing data such as program information. Note that the non-real-time reproducing data are not limited to the program information. For example, the non-real-time reproducing data may include advertisement.

The wireless communication system includes a base station 200. The base station 200 is configured to perform communication with the user terminal 100 according to the first wireless communication system wirelessly accessible to a wide area. More specifically, the base station 200 is configured to perform communication with the user terminal 100 according to a wireless access system such as a CDMA system. The base station 200 is connected to a communication network 600. The communication network 600 includes a mobile phone network, the Internet, and the like. The base station 200 transmits the non-real-time reproducing data from the program information server 400 and the real-time reproducing data from the streaming server 500 to the user terminal 100 under the base station 200.

The wireless communication system includes a base station 300. The base station 300 is configured to perform communication with the user terminal 100 according to the second wireless communication system wirelessly accessible to a narrow area, that is, wirelessly accessible to an area narrower than the area wirelessly accessible according to the first wireless communication system. More specifically, the base station 300 is configured to perform communication with the user terminal 100 according to a wireless local area network (wireless LAN). The base station 300 is connected to the communication network 600. The base station 300 transmits the non-real-time reproducing data from the program information server 400 and the real-time reproducing data from the streaming server 500 to the user terminal 100 under the base station 300.

The wireless communication system further includes a program information server 400. The program information server 400 is connected to the communication network 600. The program information server 400 transmits the non-real-time reproducing data to the base stations 200 and 300 via the communication network 600. The program information server 400 transmits to the base stations 200 and 300 the non-real-time reproducing data corresponding to the real-time reproducing data transmitted from the streaming server 500. The program information server 400 transmits the non-real-time reproducing data on a regular basis or on an irregular basis.

The wireless communication system further includes the streaming server 500. The streaming server 500 is connected to the communication network 600. The streaming server 500 delivers the real-time reproducing data to the base stations 200 and 300 via the communication network 600.

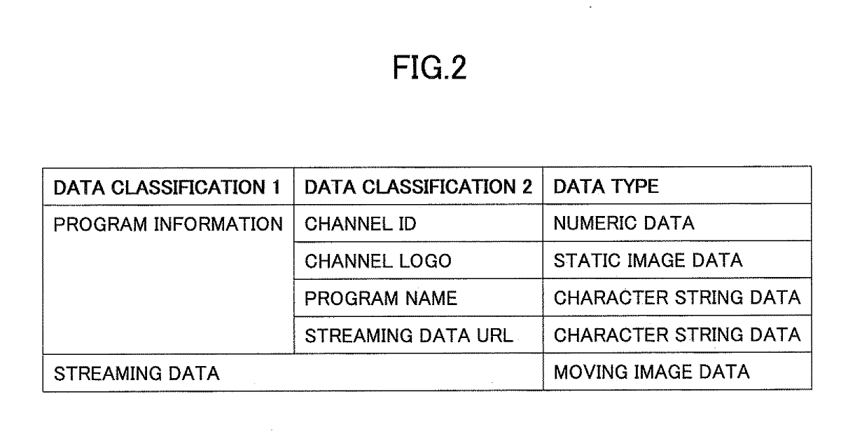

FIG. 2 illustrates classification of data transmitted from the program information server 400 and the streaming server 500, and types of such data.

The non-real-time reproducing data transmitted by the program information server 400 include program information. The program information includes a channel ID representing a channel identifier, a channel logo indicating a channel name, a program name representing a name of a program, and a uniform resource locator (URL) for streaming data (hereinafter simply called “streaming data URL”) representing location of streaming data. The channel ID is represented by numerical data, the channel logo is represented by static image data, the program name is represented by character string data, and the streaming data URL is represented by character string data.

The real-time reproducing data transmitted by the streaming server 500 include streaming data. The streaming data are represented by moving image data or video.

User Terminal 100

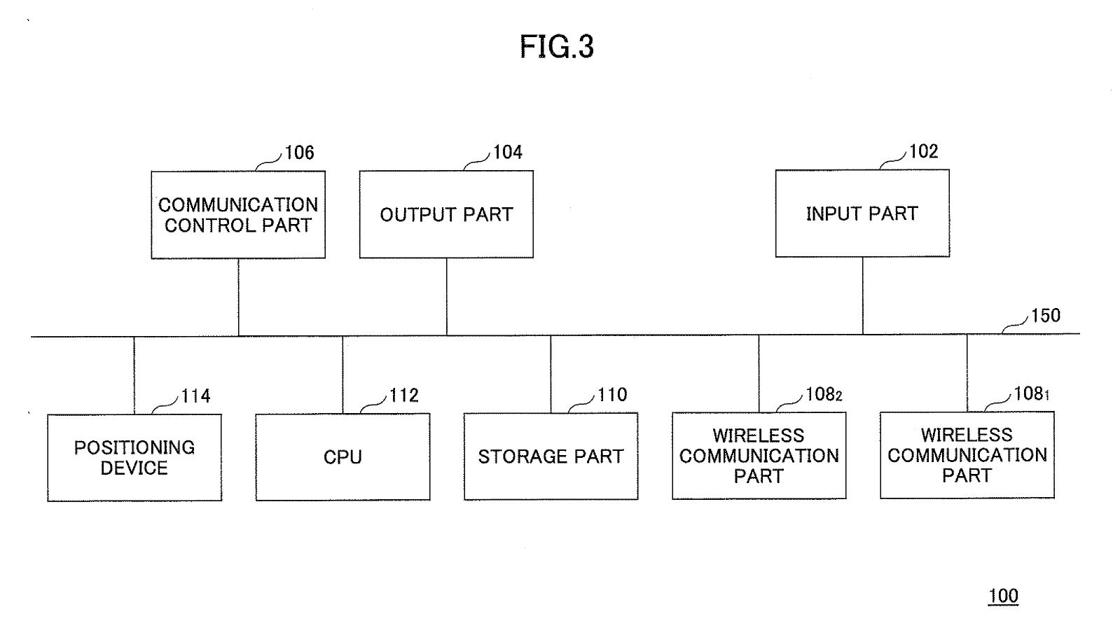

FIG. 3 is a diagram illustrating a user terminal 100 according to an embodiment. FIG. 3 specifically illustrates a hardware configuration of the user terminal 100.

The user terminal 100 includes an input part 102, an output part 104, a communication control part 106, a wireless communication part 108₁, a wireless communication part 108₂, a storage part 110, a central processing unit (CPU) 112, and a positioning device 114.

The CPU 112 is configured to control the input part 102, the output part 104, the communication control part 106, the wireless communication part 108₁, the wireless communication part 108₂, the storage part 110, and the positioning device 114. The CPU 112 is configured to function based on programs stored in the storage part 110.

The storage part 110 stores applications, and an operating system (OS). The applications are software serving as functions to execute processing of tasks that a user operates on the user terminal 100. The operating system (OS) is software providing an interface that is abstraction of hardware to the application software.

The input part 102 may be composed of a keyboard, and a mouse via which the user inputs data or sends instructions to the user terminal 100. The input part 102 may be formed of a touch panel. The input part 102 may also be formed of a microphone via which the user's voice is input. Note that the voice includes a message addressed to a recipient of the message, or instructions to the user terminal 100. The instructions may be addressed to the operating system or the applications.

The output part 104 may be composed of a display on which a processing status or a processing result is displayed. The output part 104 may also be formed of a speaker via which sound addressed to the user is output. The processing status or the processing result include those associated with the operating system or the applications. Examples of the display includes a liquid crystal display (LCD), a cathode ray tube (CRT) display, a plasma display panel (PDP), and an organic EL (electroluminescent) display, and the like.

The communication control part 106 is configured to control the transmission of an uplink signal. More specifically, the communication control part 106 controls the transmission of a channel ID request and a program name request to the program information server 400. The communication control part 106 also controls the transmission of a streaming data request to the streaming server 500.

The communication control part 106 is configured to control the transmission of a downlink signal. More specifically, the communication control part 106 controls the reception of channel logo information, streaming data URL information, and program name information from the program information server 400. The communication control part 106 also controls the reception of the streaming data from the streaming server 500.

The wireless communication part 108₁ is configured to control the communication control part 106 such that a wireless communication is performed between the user terminal 100 and the base station 200 according to the first wireless communication system wirelessly accessible to a wide area. The wireless communication part 108₁ may be a wireless interface. The first communication system includes a global system for mobile communications (GSM, registered trademark), a wideband code division multiple access (W-CDMA), and a long-term evolution (LTE). The first communication system may also include a wireless access system subsequent to LTE. That is, the first communication system includes a communication system utilized by a mobile phone. For example, the wireless communication part 108₁ is configured to control the communication control part 106 such that an uplink signal is converted into a wireless signal to be transmitted. The wireless communication part 108₁ also converts the wireless signal from the base station 200 into a baseband signal.

The wireless communication part 108₂ is configured to control the communication control part 106 such that a wireless communication is performed between the user terminal 100 and the base station 300 according to the second wireless communication system wirelessly accessible to a narrow area, that is, wirelessly accessible to an area narrower than the area wirelessly accessible according to the first wireless communication system. The wireless communication part 108₂ may be a wireless interface. More specifically, the wireless communication part 108₂ is configured to perform communication between the user terminal 100 and the base station 300 according to a wireless local area network (wireless LAN). For example, the wireless communication part 108₂ is configured to control the communication control part 106 such that an uplink signal is converted into a wireless signal to be transmitted. The wireless communication part 108₂ also converts the wireless signal from the base station 300 into a baseband signal.

The user terminal 100 according to the embodiment that includes two wireless communication parts, namely, the wireless communication parts 108₁ and 108₂ are described; however, the user terminal 100 may include three or more wireless communication parts. That is, the user terminal 100 may include three or more wireless interfaces.

The positioning device 114 is configured to locate a position of the user terminal 100. More specifically, the positioning device 114 may be a global positioning system (GPS) receiver device. The GPS receiver device locates a position of the GPS receiver device based on a positioning signal transmitted from a not-illustrated a GPS satellite. The positional information may be represented by longitude and latitude. The positional information may also be represented by altitude in addition to longitude and latitude.

Function of User Terminal 100

Next, functions of the user terminal 100 according to the embodiment are described.

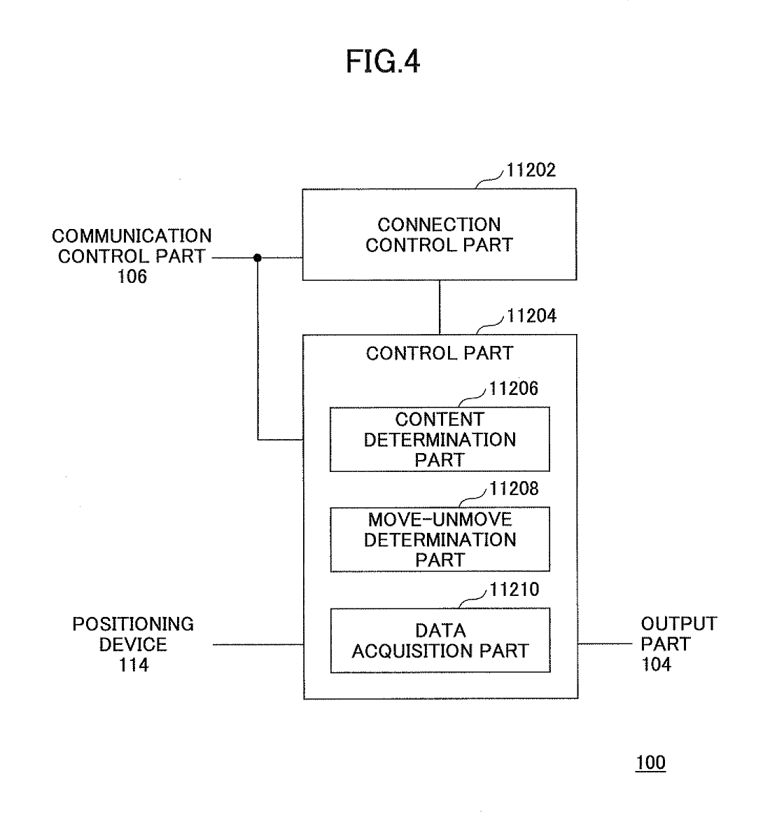

FIG. 4 is a functional block diagram illustrating the user terminal 100 according to the embodiment.

The functions represented by the functional block diagram in FIG. 4 may mainly be executed by the CPU 112. More specifically, the functions represented by the functional block diagram in FIG. 4 may mainly be executed by the CPU 112 based on the applications stored in the storage part 110.

The CPU 112 serves as a connection control part 11202. More specifically, the connection control part 11202 performs connection processing between the base station 200 and the user terminal 100 by causing the communication control part 106 to control the wireless communication part 108₁. The connection control part 11202 inputs into a control part 11204 information indicating whether the connection processing between the base station 200 and the user terminal 100 has been completed (hereinafter simply called “base station 200 connection information”).

The connection control part 11202 further performs connection processing between the base station 300 and the user terminal 100 by causing the communication control part 106 to control the wireless communication part 108₂. The connection control part 11202 inputs into the control part 11204 information indicating whether the connection processing between the base station 300 and the user terminal 100 has been completed (hereinafter simply called “base station 300 connection information”).

The CPU 112 also serves as a content determination part 11206. The content determination part 11206 receives a downlink signal from the communication control part 106. The content determination part 11206 is configured to determine content included in a downlink signal from the base station 200 or 300. More specifically, the content determination part 11206 is configured to determine whether the content included in the downlink signal from the base station 200 or 300 corresponds to real-time reproducing data. The content determination part 11206 inputs into a data acquisition part 11210 information indicating whether the content included in the downlink signal (hereinafter simply called “content information”) corresponds to real-time reproducing data.

The CPU 112 also serves as a move-unmove determination part 11208. The move-unmove determination part 11208 receives positional information from the positioning device 114. The move-unmove determination part 11208 is configured to determine a position of the user terminal 100 as “moved”, when a distance from previous positional information (i.e., a distance between the previous positional information and current positional information) is greater than or equal to a predetermined threshold, based on positional information from the positioning device 114. The move-unmove determination part 11208 is also configured to determine the position of the user terminal 100 as “unmoved”, when a distance from previous positional information is less than the predetermined threshold, based on positional information from the positioning device 114. The predetermined threshold may be set based on a size of a cell of the second communication system. The move-unmove determination part 11208 inputs into the data acquisition part 11210 information indicating whether the position of the user terminal 100 is being moved (hereinafter simply called “mobile information”).

The user terminal 100 also serves as the data acquisition part 11210. The data acquisition part 11210 receives the base station 200 connection information and the base station 300 connection information from the connection control part 11202, the content information from the content determination part 11206, and the mobile information from the move-unmove determination part 11208. The data acquisition part 11210 is configured to determine a communication system to be utilized for acquiring the content based on input information. The data acquisition part 11210 is configured to acquire content according to the communication system utilized for acquiring the content.

More specifically, the data acquisition part 11210 controls the acquisition of content according to the second communication system when content information indicates the real-time reproducing data, and the mobile information indicates “unmoved”. More specifically, the data acquisition part 11210 controls the acquisition of content such that the data acquisition part 11210 acquires the content according to the first communication system when the content information indicates the real-time reproducing data, and the mobile information indicates “moved”.

Further, the data acquisition part 11210 controls the acquisition of content such that the data acquisition part 11210 acquires the content according to the second communication system when the content information indicates the non-real-time reproducing data, and the mobile information indicates “unmoved”. Further, the data acquisition part 11210 controls the acquisition of content such that the data acquisition part 11210 acquires the content according to the second communication system when the content information indicates the non-real-time reproducing data, and the mobile information indicates “moved”.

The wireless communication part 108₂ receives the non-real-time reproducing data based on the control of the data acquisition part 11210 regardless of whether the user terminal 100 is being moved. The non-real-time reproducing data received by the wireless communication part 108₂ are decoded based on the control of the communication control part 106. The data acquisition part 11210 outputs the decoded non-real-time reproducing data to the output part 104.

Further, when the decoded non-real-time reproducing data includes a URL indicating location (address) of the real-time reproducing data, the data acquisition part 11210 controls the access to the streaming server 500 such that the data acquisition part 11210 accesses the streaming server 500 by utilizing the URL.

Further, the real-time reproducing data are received by the wireless communication part 108₁ or 108₂ based on the control of the data acquisition part 11210. The real-time reproducing data received by the wireless communication part 108₁ or 108₂ are decoded based on the control of the communication control part 106. The data acquisition part 11210 outputs the decoded real-time reproducing data to the output part 104.

When the user terminal 100 is being moved, the load on the base station utilizing the first communication system may be reduced by causing the user terminal 100 to receive the non-real-time reproducing data via the base station utilizing the second communication system.

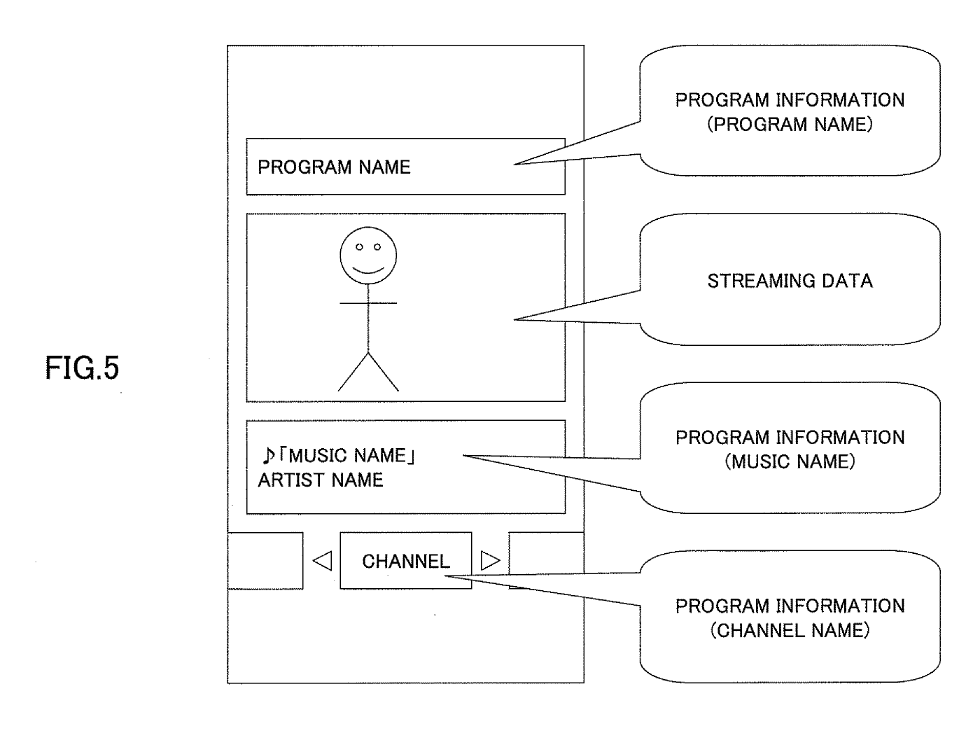

FIG. 5 illustrates an example of data displayed on the user terminal 100 according to the embodiment.

In the example illustrated in FIG. 5, a program name, a music name, and a channel name contained in the program information are illustrated as non-real-time reproducing data acquired based on the control of the data acquisition part 11210. In addition, streaming data are illustrated as the real-time reproducing data acquired based on the control of the data acquisition part 11210.

Operation of User Terminal 100 (Part 1)

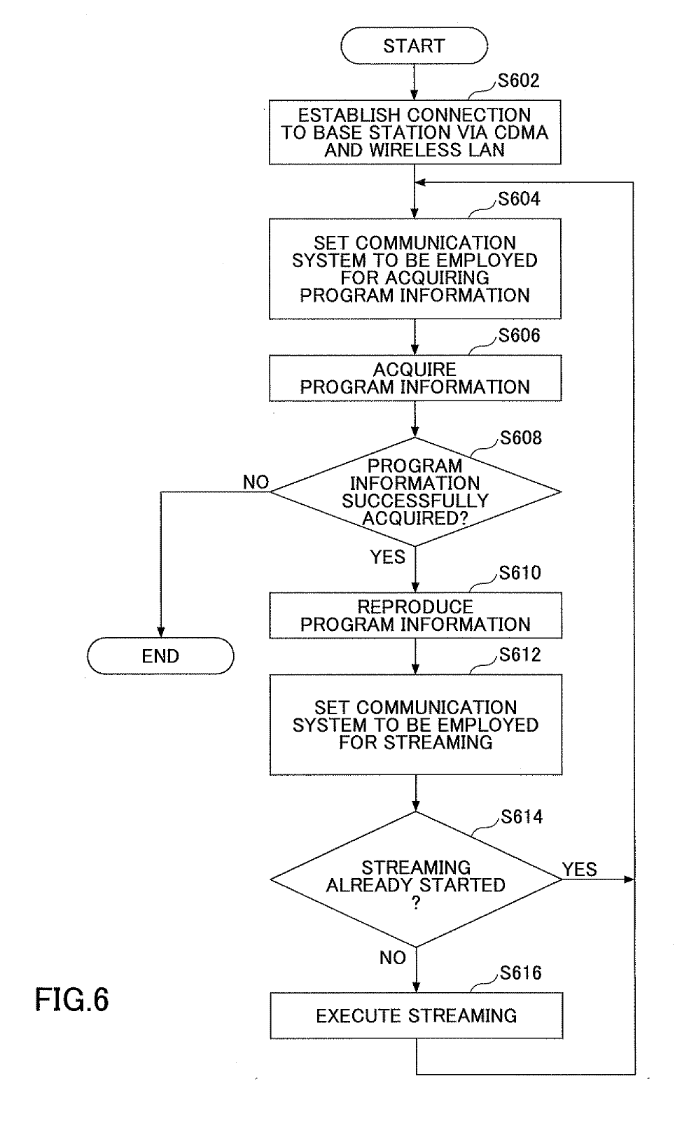

FIG. 6 illustrates an example of an operation of the user terminal 100 according to the embodiment. In the example illustrated in FIG. 6, a code division multiple access (CDMA) is applied as the first communication system and a wireless local area network (wireless LAN) is applied as the second communication system. In the example illustrated in FIG. 6, streaming data are acquired as real-time reproducing data, and program information is acquired as non-real-time reproducing data.

In step S602, the connection control part 11202 performs connection processing according to CDMA by causing the communication control part 106 to control the wireless communication part 108₁. Further, the connection control part 11202 performs connection processing according to the wireless LAN by causing the communication control part 106 to control the wireless communication part 108₂.

In step S604, the data acquisition part 11210 sets a communication system for acquiring the program information.

In step S606, the data acquisition part 11210 controls the acquisition of the program information according to the communication system set in step S604.

In step S608, when the data acquisition part 11210 is unable to acquire the program information, the data acquisition part 11210 terminates receiving of the streaming data. If the data acquisition part 11210 is unable to acquire the program information, the data acquisition part 11210 is unable to acquire a uniform resource locator (URL) that represents location or an address of the streaming data.

In step S610, when the program information is acquired in step S608, the output part 104 reproduces (i.e., outputs) the program information. That is, the data acquisition part 11210 supplies (inputs) the program information into the output part 104. The output part 104 reproduces (outputs) the program information. As a result, the program name, the music name, and the channel name are displayed as illustrated in FIG. 5.

In step S612, the data acquisition part 11210 sets a communication system for streaming (streaming of moving images).

When it is determined that the streaming has already started in step S614 (i.e., “YES” in step S614), step S604 is processed (back to step S604).

When it is determined that the streaming has not started yet (i.e., “NO” in step S614), the data acquisition part 11210 executes streaming of the moving images in step S616. That is, the data acquisition part 11210 supplies (inputs) streaming data into the output part 104. The output part 104 reproduces (outputs) the streaming data. As a result, the streaming data are displayed as illustrated in FIG. 5.

Operation of User Terminal 100 (Part 2)

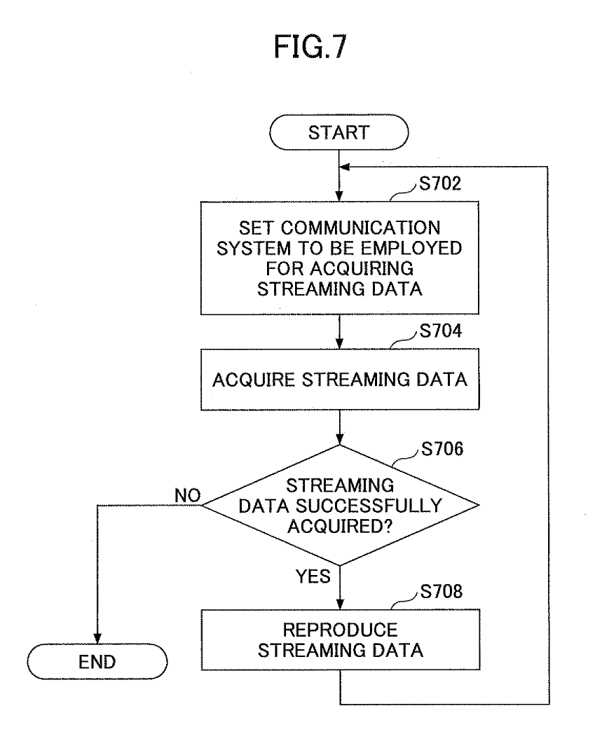

FIG. 7 illustrates an example of an operation of the user terminal 100 according to the embodiment. FIG. 7 specifically illustrates processing of step S616 in FIG. 6.

In step S702, the data acquisition part 11210 sets a communication system for acquiring the streaming data.

In step S704, the data acquisition part 11210 controls the acquisition of the streaming data according to the communication system set in step S702.

In step S706, when the data acquisition part 11210 is unable to acquire the streaming data, the data acquisition part 11210 terminates receiving of the streaming data.

In step S708, when the streaming data are acquired in step S706, the output part 104 reproduces (i.e., outputs) the streaming data. That is, the data acquisition part 11210 supplies (inputs) the streaming data into the output part 104. The output part 104 reproduces (outputs) the streaming data. As a result, the streaming data are displayed as illustrated in FIG. 5.

Operation of User Terminal 100 (Part 3)

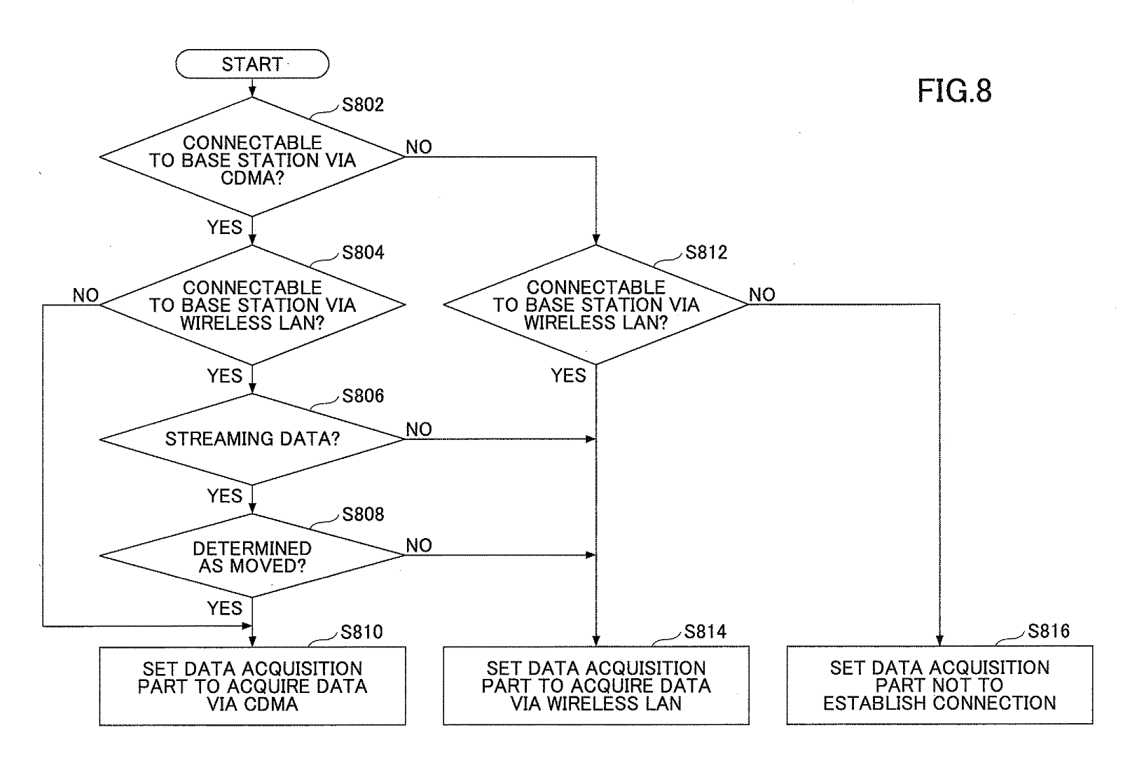

FIG. 8 illustrates an example of an operation of the user terminal 100 according to the embodiment. FIG. 8 specifically illustrates processing of steps S604 and S612 in FIG. 6, and step S702 in FIG. 7.

In step S802, the data acquisition part 11210 determines whether the data acquisition part 11210 is in a status connectable according to CDMA (hereinafter also called a “CDMA connectable status”). More specifically, the data acquisition part 11210 determines whether the user terminal 100 is in the CDMA connectable status based on the base station 200 connection information from the connection control part 11202.

In step S804, when the data acquisition part 11210 determines that the user terminal 100 is in the CDMA connectable status in step S802 (i.e., “YES” in step S802), the data acquisition part 11210 subsequently determines whether the data acquisition part 11210 is in a status connectable according to a wireless LAN (hereinafter also called a “wireless LAN connectable status”). More specifically, the data acquisition part 11210 determines whether the user terminal 100 is in the wireless LAN connectable status based on the base station 300 connection information from the connection control part 11202.

In step S806, when the data acquisition part 11210 determines that the user terminal 100 is in the wireless LAN connectable status in step S804 (i.e., “YES” in step S804), the data acquisition part 11210 subsequently determines whether content contained in a downlink signal is streaming data. More specifically, the data acquisition part 11210 determines whether the content contained in the downlink signal is the streaming data based on the content information from the content determination part 11206.

When the data acquisition part 11210 determines that the content contained in the downlink signal is the streaming data in step S806 (i.e., “YES” in step S806), the data acquisition part 11210 subsequently determines whether the user terminal 100 is being moved. More specifically, the data acquisition part 11210 determines whether the user terminal 100 is being moved based on the mobile information from the move-unmove determination part 11208.

In step S810, when the data acquisition part 11210 determines that the user terminal 100 is not in the wireless LAN connectable status in step S804 (i.e., “NO” in step S804), or the data acquisition part 11210 determines that the user terminal 100 is being moved in step S808 (i.e., “YES” in step S808), the data acquisition part 11210 is set such that the data are acquired according to CDMA.

In step S812, when the data acquisition part 11210 determines that the user terminal 100 is not in the CDMA connectable status in step S802 (i.e., “NO” in step S802), the data acquisition part 11210 subsequently determines whether the user terminal 100 is in the wireless LAN connectable status. More specifically, the data acquisition part 11210 determines whether the user terminal 100 is in the wireless LAN connectable status based on the base station 300 connection information from the connection control part 11202.

In step S814, when the data acquisition part 11210 determines that the user terminal 100 is in the wireless LAN connectable status in step S812 (i.e., “YES” in step S812), the data acquisition part 11210 is set such that the data are acquired according to the wireless LAN. Further, in step S814, when the data acquisition part 11210 determines that the content contained in the downlink signal is not streaming data in step S806 (i.e., “NO” in step S806), or the data acquisition part 11210 determines that the user terminal 100 is unmoved in step S808 (i.e., “NO” in step S808), the data acquisition part 11210 is set such that the data are acquired according to the wireless LAN.

In step S816, when the data acquisition part 11210 determines that the user terminal 100 is not in the wireless LAN connectable status in step S812 (i.e., “NO” in step S812), the data acquisition part 11210 is set such that no connection is established.

Operation of User Terminal 100 (Part 4)

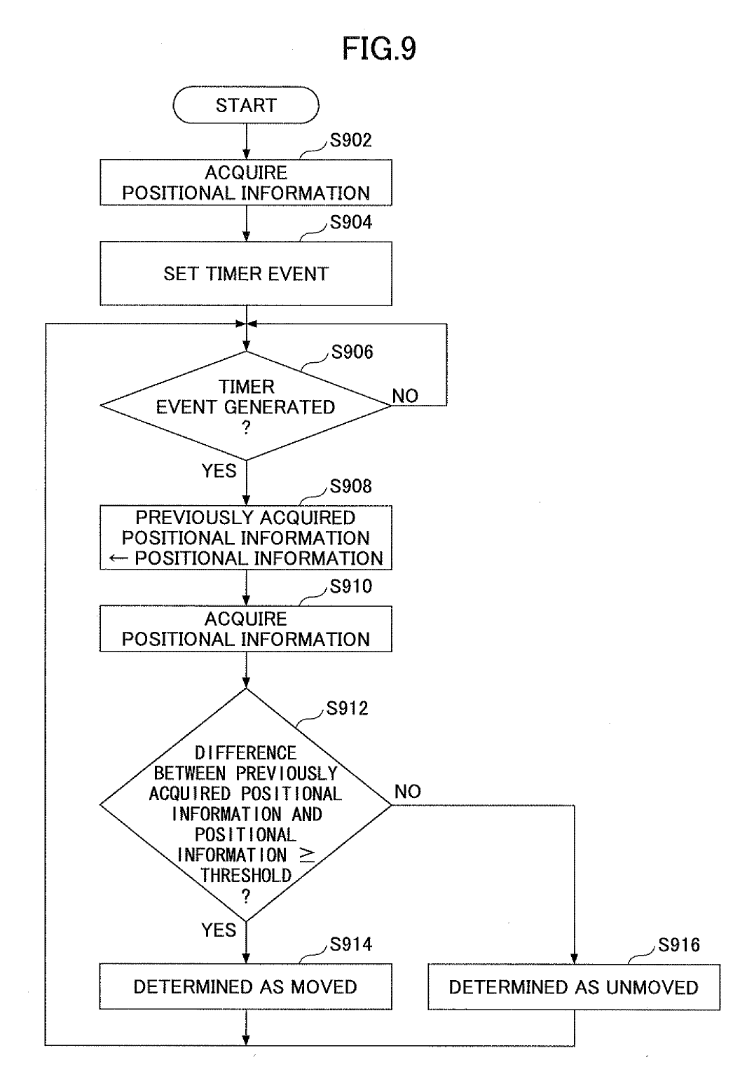

FIG. 9 illustrates an example of an operation of the user terminal 100 according to the embodiment.

In step S902, the move-unmove determination part 11208 acquires positional information. More specifically, the move-unmove determination part 11208 acquires the positional information from the positioning device 114.

In step S904, the move-unmove determination part 11208 sets a timer event. The timer event indicates a time interval for generating an event for acquiring positional information from the positioning device 114.

In step S904, the move-unmove determination part 11208 sets a timer event.

When it is determined that the timer event is generated in step S906 (i.e., “YES” in step S906), the move-unmove determination part 11208 sets positional information to previously acquired positional information in step S908.

In step S910, the move-unmove determination part 11208 acquires the positional information. More specifically, the move-unmove determination part 11208 acquires the positional information from the positioning device 114.

In step S912, the move-unmove determination part 11208 determines whether the difference between the previously acquired positional information and (current) positional information is greater than or equal to a predetermined threshold.

In step S914, when the move-unmove determination part 11208 determines that the difference between the previously acquired positional information and the current positional information is greater than or equal to the predetermined threshold in step S912 (i.e., “YES” in step S912), the move-unmove determination part 11208 determines the user terminal 100 as “moved”.

In step S916, when the move-unmove determination part 11208 determines that the difference between the previously acquired positional information and the current positional information is less than the predetermined threshold in step S912 (i.e., “NO” in step S912), the move-unmove determination part 11208 determines the user terminal 100 as “unmoved”.

Operation of Wireless Communication System

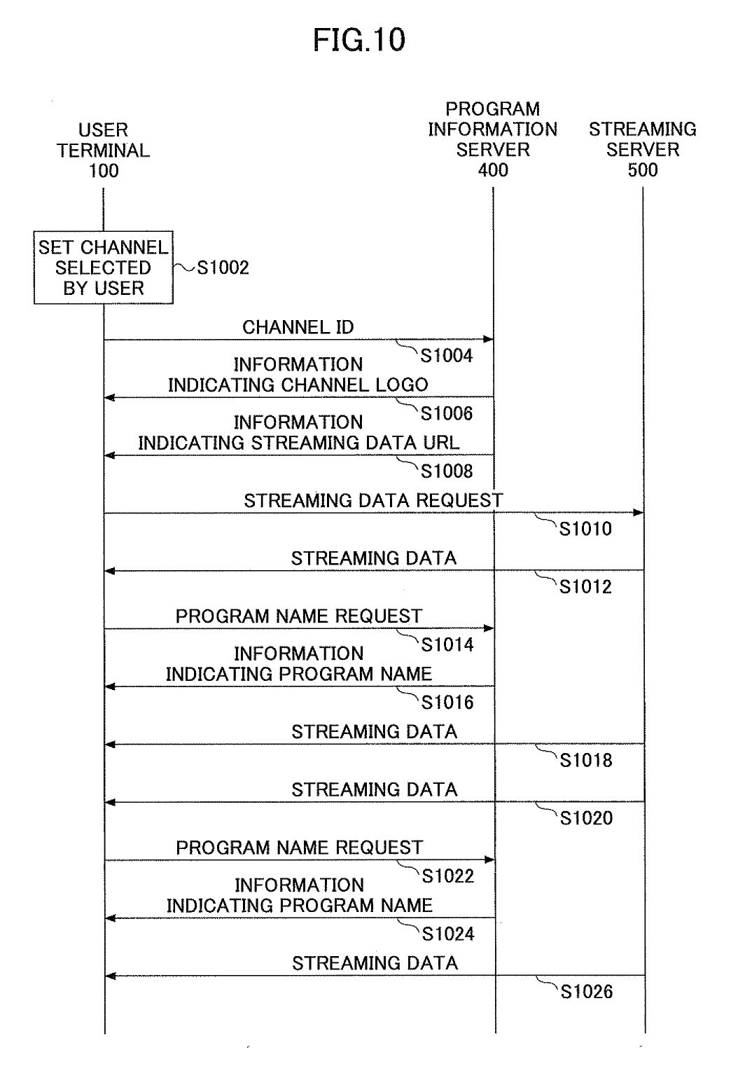

FIG. 10 illustrates an example of an operation of a wireless communication system according to an embodiment.

FIG. 10 specifically illustrates processing performed between the user terminal 100, and each of the program information server 400 and the streaming server 500.

In step S1002, the data acquisition part 11210 sets a channel selected by the user.

In step S1004, the data acquisition part 11210 controls the transmission of a channel ID representing the channel selected by the user to the program information server 400. As a result, the channel ID representing the channel selected by the user is transmitted to the program information server 400.

In step S1006, the program information server 400 transmits information representing a channel logo (hereinafter simply called “channel logo information”) to the user terminal 100. The channel logo information is received by the user terminal 100, and supplied (input) to the data acquisition part 11210. The data acquisition part 11210 supplies (inputs) the channel logo information into the output part 104. The output part 104 outputs the channel logo. As a result of outputting the channel logo from the output part 104, the channel name is displayed on the user terminal 100 as illustrated in FIG. 5.

In step S1008, the program information server 400 transmits information representing a URL of the streaming data (hereinafter simply called “streaming data URL information”) to the user terminal 100. The streaming data URL information is received by the user terminal 100, and supplied (input) to the data acquisition part 11210.

In step S1010, the data acquisition part 11210 controls the transmission of a streaming data request to the streaming server 500. More specifically, the data acquisition part 11210 accesses the URL of the streaming data reported in step S1008, and requests the streaming server 500 to transmit the streaming data. As a result, the streaming data request is transmitted from the user terminal 100 to the streaming server 500.

In step S1012, the streaming server 500 transmits the streaming data to the user terminal 100. The streaming data are received by the user terminal 100, and supplied (input) to the data acquisition part 11210. The data acquisition part 11210 supplies (inputs) the streaming data into the output part 104. The output part 104 reproduces (outputs) the streaming data. As a result of reproducing the streaming data by the output part 104, the streaming data are displayed on the user terminal 100 as illustrated in FIG. 5.

In step S1014, the data acquisition part 11210 controls the transmission of a program name request to the program information server 400. As a result, the program name request is transmitted from the user terminal 100 to the program information server 400.

In step S1016, the program information server 400 transmits information representing a program name (hereinafter simply called “program name information”) to the user terminal 100. The program name information is received by the user terminal 100, and supplied (input) to the data acquisition part 11210. The data acquisition part 11210 supplies (inputs) the program name information into the output part 104. The output part 104 outputs (displays) the program name. As a result of outputting the program name by the output part 104, the program name is displayed on the user terminal 100 as illustrated in FIG. 5.

In steps S1018 and S1020, the streaming server 500 transmits the streaming data to the user terminal 100. The streaming data are received by the user terminal 100, and supplied (input) to the data acquisition part 11210. The data acquisition part 11210 supplies (inputs) the streaming data into the output part 104. The output part 104 reproduces (outputs) the streaming data. As a result of reproducing the streaming data by the output part 104, the streaming data are displayed on the user terminal 100 as illustrated in FIG. 5.

In step S1022, the data acquisition part 11210 controls the transmission of the program name request to the program information server 400. As a result, the program name request is transmitted from the user terminal 100 to the program information server 400.

In step S1024, the program information server 400 transmits the program name information to the user terminal 100. The program name information is received by the user terminal 100, and supplied (input) to the data acquisition part 11210. The data acquisition part 11210 supplies (inputs) the program name information into the output part 104. The output part 104 outputs (displays) the program name. As a result of outputting the program name by the output part 104, the program name is displayed on the user terminal 100 as illustrated in FIG. 5.

In step S1026, the streaming server 500 transmits the streaming data to the user terminal 100. The streaming data are received by the user terminal 100, and supplied (input) to the data acquisition part 11210. The data acquisition part 11210 supplies (inputs) the streaming data into the output part 104. The output part 104 reproduces (outputs) the streaming data. As a result of reproducing the streaming data by the output part 104, the streaming data are displayed on the user terminal 100 as illustrated in FIG. 5.

According to the aforementioned embodiments, even if the user terminal is being moved, the non-real-time reproducing data may be acquired according to the communication system wirelessly accessible to a narrow area. According to the aforementioned embodiments, even if the user terminal is being moved, load on the base station utilizing the communication system wirelessly accessible to a wide area may be reduced by acquiring the non-real-time reproducing data according to the communication system wirelessly accessible to the narrow area.

The disclosed wireless communication system may select different communication systems based on the status of the user terminal and the type of data to be reproduced.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of superiority or inferiority of the invention. Although the embodiments of the present inventions have been described in detail, it should be understood that the various changes, substitutions, and alterations could be made hereto without departing from the spirit and scope of the invention.

What is claimed is:

1. A user terminal comprising:
a first wireless interface configured to perform a wireless communication according to a first communication system;
a second wireless interface configured to perform a wireless communication according to a second communication system of which an accessible area is narrower than an accessible area of the first communication system; and
a control unit configured to perform control to acquire non-real-time reproducing data from the second wireless interface while the user terminal is being moved.

2. The user terminal as claimed in claim 1, wherein
the control unit performs control to acquire real-time reproducing data from one of the first wireless interface and the second wireless interface based on whether the user terminal is being moved.

3. The user terminal as claimed in claim 1, wherein
the first wireless interface includes an interface configured to perform a wireless communication according to a communication system utilized by a mobile phone; and
the second wireless interface includes an interface configured to perform a wireless communication according to a wireless local area network (wireless LAN).

4. The user terminal as claimed in claim 1, further comprising:
an output unit configured to output the non-real-time reproducing data acquired according to the control performed by the control unit.

5. The user terminal as claimed in claim 1, wherein
the control unit performs control to acquire real-time reproducing data utilizing information contained in the non-real-time reproducing data.

6. The user terminal as claimed in claim 1, wherein
the non-real-time reproducing data includes program information.

7. The user terminal as claimed in claim 2, wherein
the real-time reproducing data includes streaming data.

8. A communication method performed by a user terminal, the communication method comprising:
acquiring non-real-time reproducing data from a wireless interface while the user terminal is being moved, the wireless interface performing a wireless communication according to a second communication system of which an accessible area is narrower than an accessible area of a first communication system.
